(19) United States
(12) Patent Application Publication
(10) Pub. No.: US 2016/0371435 A1
(43) Pub. Date: Dec. 22, 2016

(54) Offline Patient Data Verification

(71) Applicant: IMS Health Incorporated, Danbury, CT (US)

(72) Inventor: Stephan Pauletto, Duggingen (CH)

(21) Appl. No.: 14/743,398

(22) Filed: Jun. 18, 2015

(51) Int. Cl. G06F 19/00; G06F 17/30

(52) U.S. Cl. CPC G06F 19/322; G06F 17/3053; G06F 17/30525; G06F 17/30507; G06F 17/30578; G06F 17/30371

(57) ABSTRACT

Methods, system, and apparatus for verifying offline patient data. In one aspect, a method includes receiving, from a user, an input specifying field values for one or more data fields, receiving a reference file that specifies (i) one or more database rules for a particular dataset, (ii) for each database rule, a score that reflects the occurrence of the database rule within the particular dataset and a logical expression representing the application of the database rule to the particular dataset, comparing the field values specified by the input to the one or more database rules specified in the reference file, determining a confidence score associated with the received input specifying values for the one or more data fields based at least on comparing the field values specified by the input to the one or more database rules; and providing, for output, the confidence score associated with the received input.

### FIELD

The present specification relates to database architecture and specifically, data verification.

### BACKGROUND

Databases that include sensitive data such as health information include identifying data fields that pose privacy risks to patients. These databases are de-identified by pseudonymization, where identifying data fields are replaced by one or more artificial identifiers such as pseudonyms. Because identifying data fields are de-identified, verification of field values such as the detection of duplicate values is often difficult because the data is undetectable after de-identification.

### SUMMARY

Data duplication has significant performance and data integrity impacts within patient databases and applications, such as electronic health records software, that access information contained in the patient databases. For example, duplicate patient data may cause applications to malfunction due to data redundancy errors or reduce the accuracy of patient datasets for longitudinal clinical studies based on information extracted from large patient databases.

Techniques to remove data duplication in databases often include processing duplicate records after information has already been received from a data source and archived in the databases. For example, manual and semi-automatic data analysis and curation techniques for duplicate data involves initially determining which particular records are within large databases problematic and then performing time consuming operations to remove the records. Since patient databases include large numbers of records, these techniques are often prohibitively costly and/or involve significant resources in commercial practices.

Accordingly, one innovative aspect of the subject matter described in this specification can be embodied in a method to perform offline detection and prevention of multi-purpose data duplication prior to database-level record generation. For instance, the method may be executed at the data source prior to generation and de-identification of patient data to reduce the complexity in removing duplicate records after generation and de-identification. For example, data record information entered at the data source such as a data supplier database may be determined if it likely represents a duplicate record using a confidence score that represents the uniqueness of the data record information compared to particular database rules that specify particular data verification techniques.

In some aspects, the subject matter described in this specification may be embodied in methods that may include: receiving, from a user, an input specifying field values for one or more data fields; receiving a reference file that specifies (i) one or more database rules for a particular dataset, (ii) for each database rule, a score that reflects the occurrence of the database rule within the particular dataset and a logical expression representing the application of the database rule to the particular dataset; comparing the field values specified by the input to the one or more database rules specified in the reference file; determining a confidence score associated with the received input specifying values for the one or more data fields based at least on comparing the field values specified by the input to the one or more database rules; and providing, for output, the confidence score associated with the received input.

Other versions include corresponding systems, apparatus, and computer programs, configured to perform the actions of the methods encoded on computer storage devices.

These and other versions may each optionally include one or more of the following features. For instance, in some implementations, receiving the input specifying field values for one or more data fields comprises receiving input that includes identifying patient information.

In some implementations, the identifying patient information includes at least one of: first name, last name, date of birth, personal contact number, work contact number, city of residence, state of residence, zip code, driver license number, email address, physical street address, or social security number.

In some implementations, the confidence score represents a likelihood that the input specifying field values for the one or more data fields includes duplicate data within the particular dataset.

In some implementations, determining the confidence score associated with the received input specifying values for the one or more data fields comprises comparing the specified values for the one or more data fields to reference statistical data.

In some implementations, comparing the field values specified by the input to the one or more database rules specified in the reference file includes the actions of: extracting (i) field values and (ii) record values from the received input specifying field values for the one or more data fields, comparing the extracted field values against the one or more database rules in a field scope included in the reference file, and comparing the extracted record values against the one or more database rules in a record scope included in the reference file.

In some implementations, the method further includes: parsing a particular dataset including one or more field values associated with one or more data fields, determining that at least one of the field values contains duplicate values, generating one or more duplication rules based at least on the data fields associated with the at least one of the field values containing duplicate values, for each of the one or more duplications rules, (i) calculating a score representing a number of occurrences of the data fields associated with the at least one of the field values containing duplicate values, and (ii) determining a logical expression representing the application of the duplication rule to the particular dataset, generating a reference file that specifies (i) the one or more duplication rules for the particular dataset, and (ii) for each database rule, the score that reflects the occurrence of the data duplication rule within the particular dataset and the logical expression representing the application of the database rule to the particular dataset.

In some implementations, the method further includes: determining that the value of the confidence score associated with the received input specifying values for the one or more data fields is less than a threshold value, in response, providing an instruction to a user to submit an additional input specifying different values for the one or more data field, determining that the additional input is valid based at least on determining that a second confidence score associated with the received additional input is greater than the threshold value.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1A-1C illustrate example systems for performing offline data verification.

FIG. 2 illustrates an example reference file generated from an example data source.

FIGS. 3A-3B illustrate example record processing logic for new data records to be inserted into a dataset.

FIG. 4 illustrates example statistical parameters used to calculate a confidence score associated with data entered.

FIG. 5 is an example process for detecting duplicate data in a patient database.

In the drawings, like reference numbers represent corresponding parts throughout.

### DETAILED DESCRIPTION

In general, the subject matter described in this specification may involve the use of two primary software applications: (i) an internal module used to generate a reference file based on patient data received either from database sources, or artificially generated training data that is based on actual patient data, and (ii) an external module used to compare input data at a data source interface with the reference file to determine if the input data contains duplicate data. In some instances, the reference file may be successively trained using actual patient data from multiple data sources to refine the data verification techniques.

The internal module initially investigates a dataset with duplicate patient data fields. The internal module can be configured such that it investigates the dataset without requiring an online connection with the data source that generates the dataset. The output of the investigation is a reference file that specifies a list of database rules and a score for each database rule that reflects the occurrence of the data duplication rule within the dataset. The external module encrypts the identifiable patient data fields using a de-identified key and exchanges the data with other applications or data sources.

A user may also use the external module to compare input field values at a data source such as an electronic health record interface against the database rules specified in the reference file. Based on the comparison, statistical parameters may be used to calculate a confidence value that represent the likelihood that the input field value is a unique value for the input record identifier such as a patient ID using each data duplication rule. In some implementations, a second non-confidence score that represents the likelihood that the input field value is a duplicate value may also be calculated. In such implementations, the absolute difference between the confidence and the non-confidence scores may then be compared to a threshold value to designate whether the input field value is a unique value for the patient record identifier. More specific details are described in the descriptions below.

As used herein the term “real time” refers to transmitting or processing data without intentional delay given the processing limitations of the system, the time required to accurately measure the data, and the rate of change of the parameter being measured. For example, “real time” data streams should be capable of capturing appreciable changes in a parameter measured by a sensor, processing the data for transmission over a network, and transmitting the data to a recipient computing device through the network without intentional delay, and within sufficient time for the recipient computing device to receive (and in some cases process) the data prior to a significant change in the measured parameter. For instance, a “real-time” data stream for a slowly changing parameter (e.g., user input specifying data fields) may be one that measures, processes, and transmits parameter measurements every hour (or longer) if the parameter (e.g., field value) only changes appreciably in an hour (or longer). However, a “real-time” data stream for a rapidly changing parameter (e.g., multiple field values) may be one that measures, processes, and transmits parameter measurements every minute (or more often) if the parameter (e.g., field value) changes appreciably in a minute (or more often).

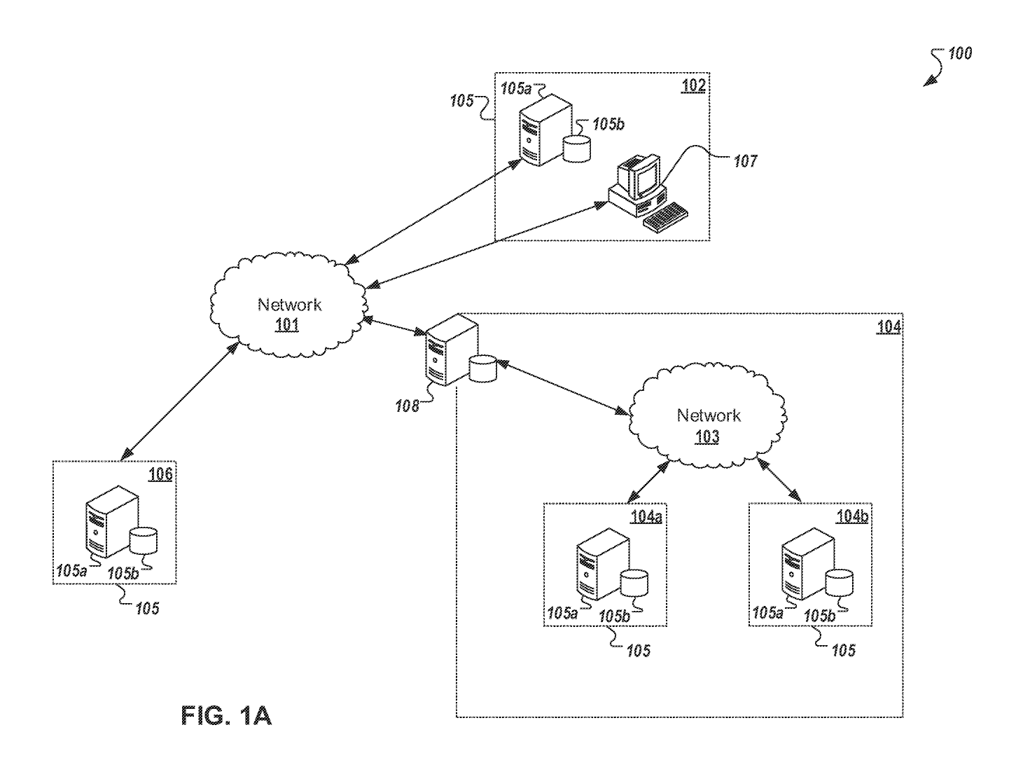

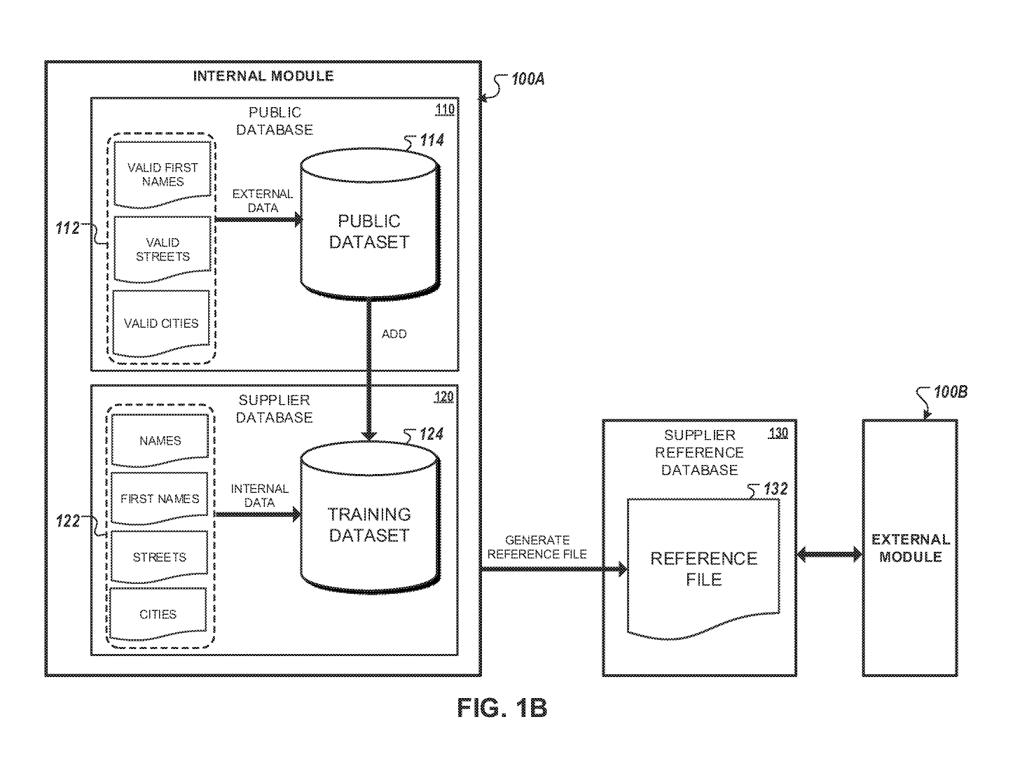

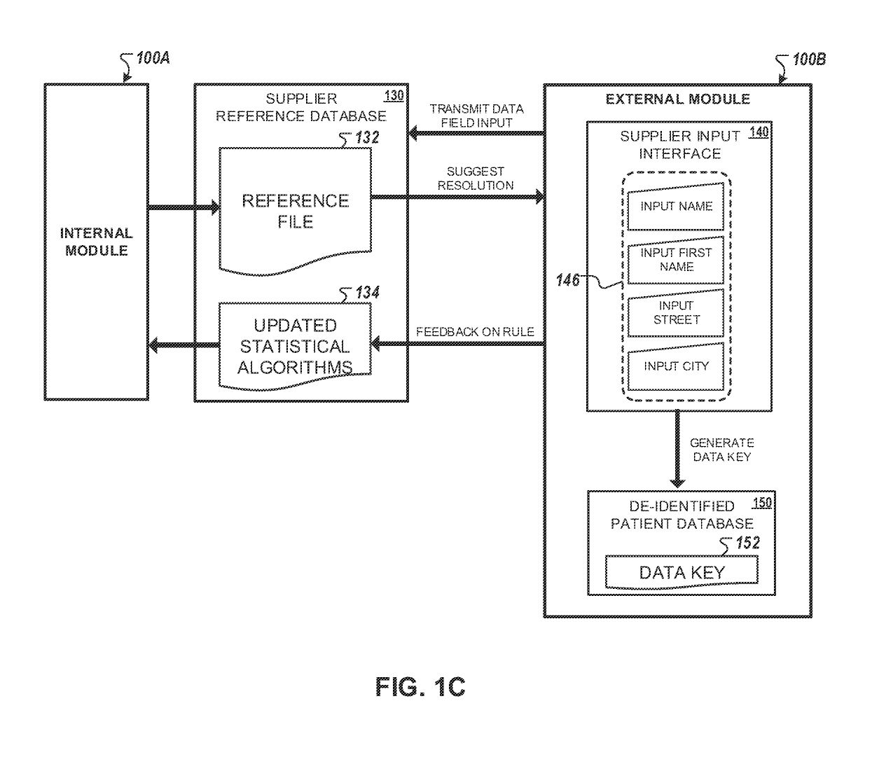

FIGS. 1A-1C illustrate example systems for performing offline data verification. FIG. 1A represents an example system 100 that can execute implementations of the present disclosure. FIG. 1B represents an internal module 100A that may include public data 110 including data fields 112 such as, for example, “valid first names,” “valid streets,” and “valid cities,” as well as a public dataset 114. The internal module 100A also includes supplier data 120 including data fields 122 such as, for example, “names,” “first names,” “streets,” “cities,” as well as a training dataset 124. The supplier reference data 130 may include a reference file 132, which exchanges communications with an external module 100B. FIG. 1C represents an external module 100B that may include a supplier input interface 140 including input data fields 146 such as, for example, “input name,” “input first name,” “input street,” and “input city,” and additionally de-identified patient database 150 including a data key 152.

Referring now to FIG. 1A, the system 100 may execute implementations of the present disclosure. The example system 100 is illustrated in a health care data services environment, including a client organization 102, an information services organization (ISO) 104, and one or more external systems 106. The ISO 104 may be a business, non-profit organization, or government entity that provides information services to other organizations or individuals. Client organization 102 may be, for example a pharmaceutical manufacturer, a hospital, a pharmacy, a health insurance entity, or a pharmaceutical benefit manager. The external systems 106 may be, for example, third-party data providers such as government agency data systems.

Each of the client organization 102, the ISO 104, and the external systems 106 include one or more computing systems 105. The computing systems 105 can each include a computing device 105a and computer-readable memory provided as a persistent storage device 105b, and can represent various forms of server systems including, but not limited to a web server, an application server, a proxy server, a network server, or a server farm. In addition, each of the client organization 102, the ISO 104, and the external systems 106 can include one or more user computing devices 107. However, for simplicity, a user computing device 107 is only depicted at the client organization 102. Computing devices 107 may include, but are not limited to, one or more desktop computers, laptop computers, notebook computers, tablet computers, and other appropriate devices.

In addition, the ISO 104 can include, for example, one or more data reconciliation systems (DRS) 108. A DRS 108 can be one or more computing systems 105 configured to perform data reconciliation between distinct electronic datasets distributed across multiple separate computing systems in accordance with implementations of the present disclosure. The ISO 104 also includes one or more data repository systems 104a, 104b. In some examples, the data repository systems 104a, 104b include one or more databases storing data compiled by the ISO 108. In some implementations, one or more of the data repository systems 104a, 104b can be a secure data repository storing sensitive data in one or more secure datasets. For example, a secure data repository can be a data repository with restricted access and may require special credentials to obtain access. For example, a secure data repository may contain confidential information, personally identifiable information or other protected information. Furthermore, the data in the secure data repository can be encrypted.

The DRS 108 at the ISO 104 communicates with computing systems 105 at the client organization 102 and the external systems 106 over network 101. The network 101 can include a large network or combination of networks, such as a PSTN, a local area network (LAN), wide area network (WAN), the Internet, a cellular network, a satellite network, one or more wireless access points, or a combination thereof connecting any number of mobile clients, fixed clients, and servers. In some examples, the network 101 can be referred to as an upper-level network. In some examples, ISO 104 may include, for example, internal network (e.g., an ISO network 103). The DRS 108 can communicate with the computing systems 105 of the one or more of the data repository systems 104a, 104b over the ISO network 103.

Referring now to FIG. 1 B, the internal module 100A may be a software module that extracts patient information from the public database 110 and sends the corresponding patient information to the supplier database 120. For example, the public database 110 may be any data source that contains valid patient information such as the data fields 112. For instance, the public database 110 may be a hospital database that includes patient registries including key information for admitted patients. In other instances, the public database 110 may also include publicly available patient information such as surgical outcomes or hospital discharge information. As represented in the example, the data fields 112 within the public database 110 may include valid first names, valid streets, or valid cities. The data fields 112 are associated with stored field values for the each data field and may be stored on the public database 110.

The internal module 100A may extract the data fields 112 from the public database 110 to generate the public dataset 114 that may include duplicate data field values within the public database 110. For example, the internal module 100A may initially parse the public database 110 and identify data fields with similar or identical values using recursive techniques to identify duplicate data field values. The internal module 110 may then add the generated public dataset 114 to the training dataset 124 in the supplier database 120.

The supplier database 120 may be a database operated and maintained by a healthcare data provider that includes identifying patient information. For instance, the supplier database 120 may be any data provider that is compliant with the Health Insurance Portability and Accountability Act (HIPPA) and archives patient data from various data sources that collect and store patient information such as hospital, clinical research laboratories, or medical device companies. As represented in the example, the supplier database 120 may include data fields 122 such as names, first names, streets, or cities. In other instances, the data fields may also include relevant medical history, immunization records, or other identifying information that may be stored on the supplier database 120.

The internal module 100A may generate a training set 124 that contains patient information from the public dataset 114 as well as internal patient information stored on the supplier database 120. For example, the training dataset 124 may be a compilation of patient data archived from data sources that may include duplication data. In some implementations, the training dataset 124 may include artificially generated training data that includes a predetermined quantity of duplicate patient data.

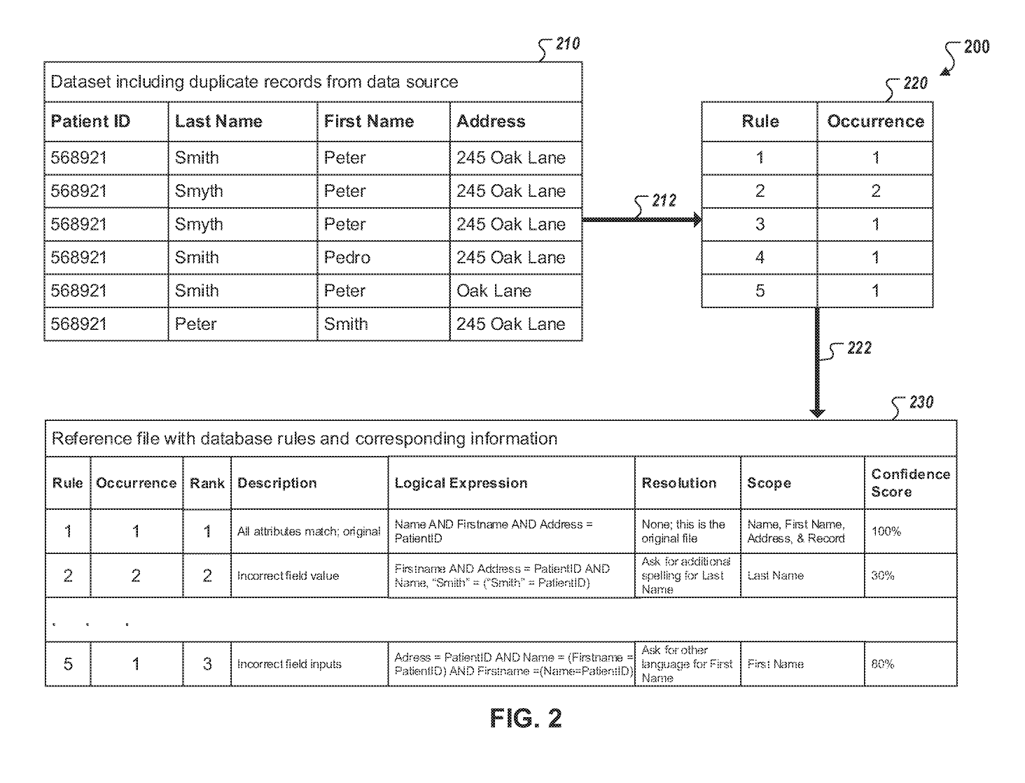

The internal module 100A may, after generating the training dataset 124, parse the training dataset 124 to extract duplicate data fields 122 that are included in the training dataset 124 and determine a set of database rules based on the duplicate data. For example, the database rules may be specified for particular data fields that include duplicate field values, or be specified based on incorrect field values compared to expected field values. The internal module 100A may generate a reference file 132 that specifies one or more database rules and for each database rule, a score that represents the number of occurrences for each data duplication rule in the training dataset 124. More specific details regarding the generation of the reference file 132 are discussed in descriptions for FIG. 2.

The supplier reference database 130 may be a separate module that exchanges communications with the internal module 100A and the external module 1008. As discussed more specifically below in FIG. 1C, the supplier reference database 130 may exchange communications with the external module 100B to compare the information contained in the reference file 132 and the information stored in the external module 1008.

The reference file 132 may be a data file or object that includes logical expressions used to determine if the field values for the data fields 112 or 122 are duplicate values, statistical data representing the occurrence of the duplication rules associated with the duplicate values, and/or resolution protocols instructing the database how to handle duplicate values. For example, the reference file 132 may include instructions for the external module 1008 to handle duplicate values for particular data fields.

Referring now to FIG. 1C, the reference file 132, which is generated from the training dataset 124 of the internal module 100A as described previously, may be used to detect duplicate field inputs by a user on the supplier input interface 140. The supplier input interface 140 may be any interface, for example, a graphical user interface, that displays the input data fields 146 and accepts user input of field values that specify patient information. The supplier input interface 140 may enable a user to input patient information for a new patient record including the data fields 146 to be inserted into the supplier database 120.

The external module 100B may transmit the user input specifying field values for the input data fields 146 to the supplier reference database 130. The supplier reference database 130 may initially parse the received user input from the external module 100B by comparing the received user input against the duplication rules included in the reference file 132 in the order listed in the reference file 132. For example, based on the comparison, the supplier reference database 130 may calculate a confidence score that represents the probability that the user input is likely to be a duplicate input based on the duplication rules included in the reference file 132.

The supplier reference database 130 may then determine a corresponding resolution for the user input to determine whether the input is duplicate data and transmit the resolution to the external module 1008. For example, if the data duplication rule indicates that the user input may include a misspelled field value for “Name” field, then the supplier reference database 130 may transmit a corresponding resolution asking the user to provide another spelling for the “Name” field.

After the resolution has been transmitted, the external module 100B may prompt a user for and accept an additional input for a particular data field 146 that is potentially identified as a duplicate field based on the data duplication rule included in the reference file 132. In response to the additional user input, the supplier reference database 130 may calculate the potential increase or decrease in the confidence score using similar techniques to determine if the additional user input may also be a duplicate value. For example, in some instances, if the additional user input is less likely to be a duplicate value, then the confidence score may be increased for the additional user input compared to the original user input. For example, if the original user input for the “Name” field includes a typo such as “SMYTH” that makes it similar to an existing field value “SMITH, and the user resubmits an additional user input with a corrected spelling “SMITHSON,” the confidence score of the additional input may be increased compared to the original field value input. In other instances, if the additional user input is more likely to be a duplicate value, then the confidence score may be decreased for the additional user input compared to the original user input. For example, if the original user input for the “Name” field includes “SMYTHH,” which is less likely to be associated with “SMITH,” but the user resubmits an additional user input with “SMYTH,” the confidence score of the additional input may be decreased since the additional input is more likely to be a duplicate value of “SMITH.”

In some implementations, after the supplier reference database 130 processes the additional user input on the supplier input interface 140, the supplier reference database 130 may generate updated statistical algorithms 134 associated with each of the data duplication rules included in the reference file 132 and transmit the updated statistical algorithms 134 to the internal module 100A. For example, the updated statistical algorithms 134 may represent logical expressions used to calculate the confidence value of the input data fields 146 as represented more specifically in FIG. 2.

The external module 1008 may de-identify the input data fields after receiving a resolution for handling duplicate input data and receiving additional user input for the field values of the input data fields 146. The external module 100B may de-identify the input data fields by encrypting patient identifying information such as name, address, social security number (SSN), using a data key 152 and store the de-identified input data fields 146 into the de-identified patient database 150. The data key 152 may be a private key that produces a reproducible encrypted version of the patient identifying information that uniquely identifies the input data fields 146 without including the patient identifying information. For example, the data key 152 may specify an encryption algorithm for de-identifying patient information in the input data fields 146, and a separate decryption algorithm for re-identifying the de-identified input data fields 146 to determine the original input field values once the data fields 146 have been de-identified. In some implementations, the computing system 100 (e.g., the computing system executing the external module 100B) automatically causes a prompt to be displayed to a user, prompting the user to specify field values for the input data fields 146 such as, for example, the “input name.” In some implementations, the prompt may be displayed to the user in real time. For instance, the external module 100B may receive a user input at the supplier input interface 140 indicating the creation of a new data record and in response, display the prompt to the user without intentional processing delay. In some examples, the prompt may be displayed to the user before the user completes particular actions after specifying the field values for the input data fields 146 such as completing and transmitting an electronic data form including the input field values.

FIG. 2 illustrates an example system 200 for generating a reference file from a dataset. The system 200 may include a dataset 210 from a data source, a rule generation table 220, and a reference file 230. As shown in the example, the dataset 210 may include data fields with duplicate values such as “568921,” “Smith,” “Peter,” and “245 Oak Lane” for the data fields “Patient ID,” “Last Name,” “First Name,” and “Address,” respectively. The dataset 210 may be extracted from any data source that archives patient information as discussed previously. The dataset 210 may be transmitted to the internal module 100A as described in FIGS. 1A-1B to generate the rule generation table 220 using a process 212.

The process 212 describes the process of determining a set of database rules based on the attributes of the duplicate data fields present within the dataset 210. For example, the internal module 100A may parse the dataset 210 using a unique identifier field such as “Patient ID” to compare the field values for each data field for a particular unique identifier. As represented in the example, the dataset 210 includes duplicate field values for the data fields “Last Name,” “First Name,” and “Address” for the unique identifier value “568921.” In such an example, the internal module 100A initially determines that there are duplicate data present for this unique identifier. The internal module 100A then proceeds to formulate a set of database rules that represent various types of duplications and the number of occurrences for each rule in the rule generation table 220.

The rule generation table 220 may be a list of identified database rules identified by the internal module 100A as representing duplicate values in the dataset 210. The database rules may be identified based on the type of duplication and/or the particular data field that is identified as containing duplicate values. For example, as represented in the example, the rule generation includes five distinct rules that represents the various types of duplicate data within the dataset 210.

As shown in the example, rule 1 corresponds to the field values matching to expected values for the Patient ID such as “Smith,” “Peter,” and “245 Oak Lane” for the “Last Name,” “First Name,” and “Address.” In some implementations, this rule may be generated based on comparing the field values in the dataset 210 to original field values in an externally validated patient dataset from a data source that is known to include verified patient information. Rule 2 corresponds to duplicate data where the field value for the “Last Name” field is spelled incorrectly. For instance, where the “Last Name” field includes the field value “Smyth” instead of the expected field value “Smith,” correspond to the rule 2. Rule 3 corresponds to duplicate data where the “First Name” field includes a field value that is in a different language. For instance, where the “Last Name” field includes the field value “Pedro” instead of the expected field value “Peter” correspond to rule 3. Rule 4 corresponds to data where the “Address” field is missing a house number in the address. For instance, where the “Address” field includes the field value “Oak Lane” corresponds to rule 4. Rule 5 corresponds to data where the field values for the “Last Name” and “First Name” fields are swapped. For instance, where the “Last Name” field includes the field value “Peter” and the “First Name” field includes the field value “Smith” correspond to rule 5. Although five rules are represented in the example, other data rules may be possible based on the data included in the dataset 210.

In some implementations, where field matching for a particular unique identifier is not possible, the rules included in the rule generation table 220 may also be based on comparing field values across data fields within a particular patient record. For example, rule 5 represents an example of such a rule that is generated based on comparing the values of two data fields, “Last Name,” and “First Name” where the field values are swapped between

The rule generation table 220 may also include a score representing the number of occurrences for each rule specified in the rule generation table 220. For instance, as shown in the example, rule 2 has a score of “2,” which corresponds to the two occurrences associated with the “Smyth” values for the “Last Name” field. Once the rule generation table 220 is populated with a list of rules and scores representing their occurrences in the dataset 210, the internal module 100A may prepare a reference file 230 using a process 222.

The process 222 generally describes the process of generating a reference file 230 that identifies each particular database rule, the number of occurrences of each rule, a rank that instructs the internal module 100A how to sequentially apply the rules specified in the reference file 230, a general description of the rule, and a logical expression that represents how the rule is logically implemented within the dataset 210. For example, the reference file 230 may include a list of cumulatively generated list from multiple different datasets that include different types of duplicate data. For instance, in some implementations, the reference file 230 may be generated from multiple datasets 210 that include different patient information from various data sources. In such instances, the reference file 230 represents a dynamic collection of database rules that identifies particular data duplication trends in numerous datasets 210.

The reference file 230 may be generated by the internal module 100A based on the identified duplicate data within the dataset 210. As shown in the example, the reference file 230 includes the five rules included in the rule generation table 220 with additional information about the description of the rule and the logical expression of the rule. In some instances, logical expression may represent database extraction and manipulation queries such as structured query language (SQL), which enables the internal module 100A to determine the presence of particular types of duplicate data specified by the particular database rule. In other instances, the logical expression may represent pseudo code language used by data analytics software platforms to perform data queries to a connected database source.

The reference file 230 may also include resolutions corresponding to each database rule. For example, the resolutions may represent an instruction generated by the internal module 100A to prevent subsequent data duplication in another dataset that received new data records based on the identified duplicate data in the dataset 210 used to generate the reference file 230. For example, the resolution may include requesting additional user input for a data field based on determining that the user input may likely to be identified as duplicate data specified by the particular rule associated with the resolution. In such examples, once the internal module 100A generates a resolution, the external module 1008, which receives user input on the supplier database interface 140, may parse user input for a particular field, identify the particular rule that makes it likely to be a duplicate value and executes the resolution to prevent duplicate data from being entered into a patient database.

The reference file 230 may also include a scope that identifies the target data fields impacted by the particular database rule. For example, as represented in the example, rule 1, which determines if a patient record is an original record has a scope that includes multiple data fields because it requires the internal module 100A to assess the attributes of all of the data fields identified to determine if the record is an original record where the field values specified match the values specified in a reference dataset with verified patient information.

In another example, rules 2 and 5 respectively, have field scopes of particular fields since these rules require the internal module 100A to individually assess the values specified for a single data field. For instance, rule 2 determines whether the user input specifies an incorrect field value for a data field (e.g., “Last Name” field) such as “SMYTH” instead of an expected field value “SMITH.” Since rule 2 detects an error in the specified field value for one particular data field (e.g., “Last Name” field), its corresponding field scope is for the particular data field (e.g., “Last Name” field). Rule 5 determines whether the user input specifying a field value for a particular data field is reversed with a commonly associated data field (e.g., “Last Name” and “First Name” fields). Since rule 2 detects an error in the specified field value for one particular data field (e.g., “First Name” field) given the specified field value of a second data field (e.g., “Last Name” field), its corresponding field scope is for the particular data field (e.g., “First Name” field).

In some implementations, the reference file 230 may also include hash keys (not shown in FIG. 2) associated with each unique identifier such as, for example, the “Patient ID.” In such implementations, the hash kays may be stored in a sequential file without record delimiters and used to verify the existence of duplicate patient records within a dataset 210 without comparing individual data fields, which increases the speed of determining the presence duplicate data within a dataset 210.

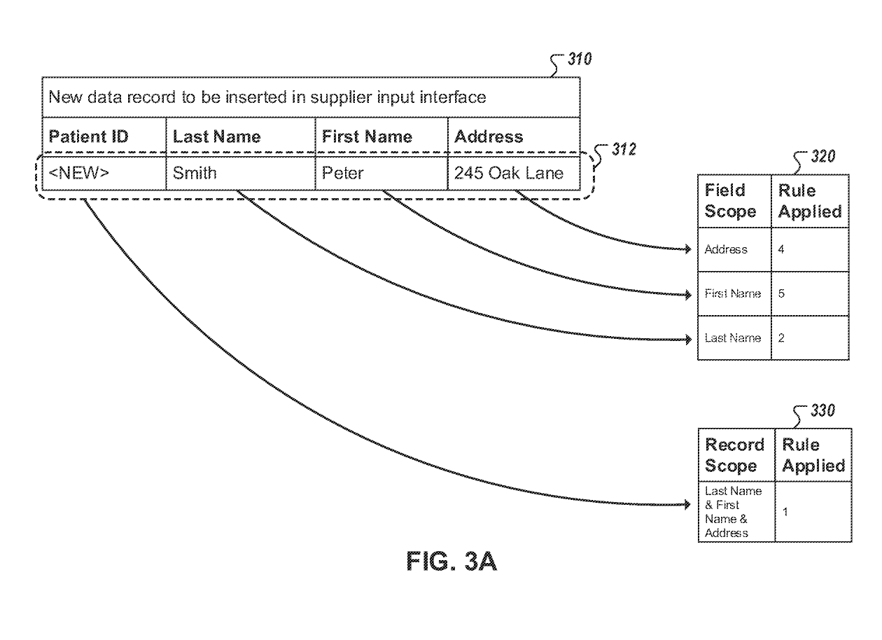

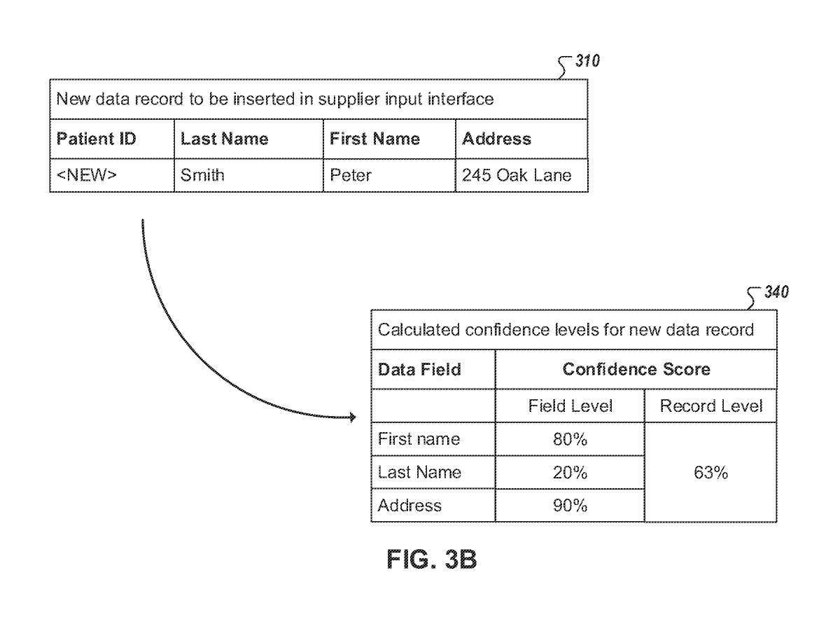

FIGS. 3A-3B illustrate example record processing logic for new data records to be inserted into a dataset. Briefly, FIG. 3A illustrates a new patient record 310 including inserted data fields 312, which are processed within a field scope 320 and a record scope 330. FIG. 3B illustrates a calculated confidence level table 340, which is calculated based on the processing logic represented in FIG. 3A.

Referring now to FIG. 3A, the new data record 310 may include patient information that does not have an existing “Patient ID” a database such as the supplier database 120. For example, the new data record 310 may include input field values 312 on the supplier input interface that specify particular field values to be included for a new identifier field within a dataset such as the dataset 210 represented in FIG. 2.

The external module 100B may initially extract the input field values 312 from the new data record 310. As represented in the example, the input field values 312 may include user input specifying “Smith,” “Peter,” and “245 Oak Lane” as field values for the “Last Name,” “First Name,” and “Address,” respectively. In some instances, these field values may be associated with a new patient that does not have an assigned unique identifier. In such instances, the external module 100B processes the new data record 310 and its corresponding input field values 312 using the field scope 320 and the record scope 330, respectively, to calculate confidence scores for both the individual input field values 312 and the new data record 310. More specific descriptions of the confidence score calculation process are provided in the descriptions for FIG. 3B.

The external module 100B initially processes the input field values 312 of each individual data field against database rules with the corresponding field scope 320 in a ranked sequence. The field scope 320 may represent the scope of the particular field values used to compare the input field values to calculate a confidence score of each the input field value 312 that represents the likelihood that the user input includes duplicate data. As shown in the example, the input field value “Smith” is processed under rule with the field scope “Last Name,” such as, for example, rule 5 as represented in FIG. 2.

In some instances, more than one database rule may be specified in the reference file 230 as having the applicable field scope 320 for a particular input field value 312. In such instances, the external module 100B may process the particular input field value 312 using a specified sequence for the multiple database rules using the ranking specified in the reference file. For example, the external module 100B may initially process the input field value 312 under the database rule with the lower ranking value specified in the reference file 230 prior to processing the same input field value 312 with the database rule with the higher ranking value.

After the external module 100B has processed each individual input field value 312 using the field scope 320, the external module 100B may then process the entire new data record 310 using the record scope 330 in the same manner as discussed above with the field scope 320. However, whereas the field scope 320 enables the external module 100B to calculate the confidence value for each individual input field value 312, the record scope 330 enables the external module 100B to calculate the confidence value for the entire record by aggregating the individual confidence scores associated with each of the individual input field values 312 as discussed more particularly below in FIG. 3B.

Referring now to FIG. 3B, the external module 100B may process the new data record 310 by running each individual input field value 312 against the rules within the field scope 320 and the record scope 330. Once each individual input field value 312 and the entire new data record 310 are both processed, the external module 100B generates the calculated confidence level table 340. The calculated confidence table 340 represents the calculated confidence levels for each individual input field value 312 using the field scope 320, as well as the calculated confidence level for the entire new data record using the record scope 330. As represented in the example, the field-level confidence level for the data field “Address” may be 90%, which represents the likelihood that the input field value “245 Oak Lane” is a value that is not a duplicate value in a particular dataset such as the dataset 210.

The record level confidence score may represent an aggregation of the field-level confidence scores for each individual input field value 312. As represented in the figure, the record level confidence score for the new data record 310 is “63%,” which represents the mean of the individual confidence scores “80%,” “20%,” and “90%.”

In some implementations, the record level confidence score may represent other forms of aggregation techniques that apply various weighting factors to each of the individual data fields based on the relative significance for each field to calibrate the record level confidence score. For example, in some databases, if the input field value for the “Address” field is more indicative of whether the new data record is a duplicate, than the external module 100B may apply a unique weighting factor that up-weights the composition of the field level confidence score of the “Address” field compared to the field level confidence scores of the other data fields to calculate a more representative record level confidence score.

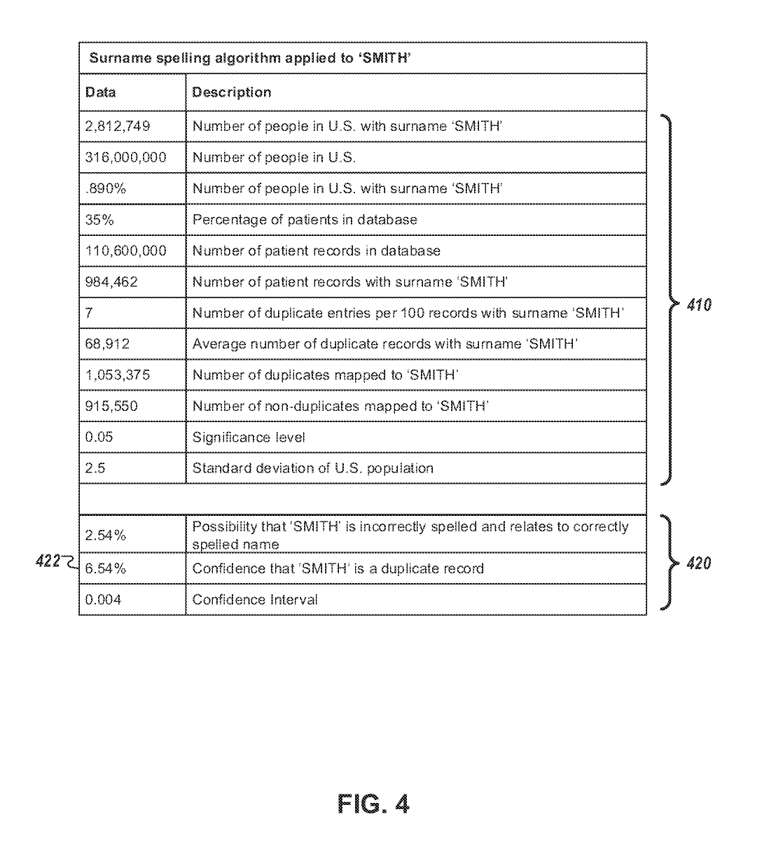

FIG. 4 illustrates example statistical parameters used to calculate confidence scores for a new data record. Briefly, a set of statistical parameters 410 may be used to calculate confidence parameters 420 including a confidence score 422.

In more detail, the set of statistical parameters 410 may be statistical reference data collected from additional knowledge sources such as additional databases, census information and/or other information sources that are updated over particular periods of time, e.g., annually. As represented in the example, the statistical parameters 410 may include patient demographic information such as the number of people within the certain geographic region such as the United States, or database-specific information such as the number of patient records within a particular dataset, or record-specific information such as the number of duplicates corresponding to the input field value “Smith.”

In some implementations, the particular statistical parameters 410 used to calculate the confidence parameters 420 may vary based on the particular database used and/or the patient information submitted on the supplier input interface 140. For example, if the external module 1008 is connected to a large database source that includes patient information from multiple international resources, than the statistical parameters 310 may be adjusted to aggregate various demographic information to more accurately reflects the probability that the input data fields 146 may contain duplicate data included within the database source. In other instances, the statistical parameters 410 may be adjusted based on the input specified for the input data fields 146. For example, if the “Input City” is “New York” in the input data fields 146, then the statistical parameters 410 used to calculate the confidence scores for the input data fields 146 may be adjusted to reflect data representative of patients located in New York.

The confidence parameters 420 may be calculated, based on the statistical parameters 410, to determine a likelihood that the new data record 310 contains duplicate values in a database such as, for example, the dataset 210. As represented in the example, the input field value “Smith” for the “Last Name” field may include statistical parameters 410, which includes relevant reference statistics that relate to the input and/or enables the external module 100B to determine a possibility that the input field value is incorrectly spelled and relates to the correctly spelled name. In the example, given the high occurrence of the patient records with the last name “Smith,” the possibility that the input field value is incorrectly spelled is relatively low (e.g., 2.54%). In other example, for instance if the input was “Smyth,” the possibility that the input value was correctly spelled may be much larger since the high occurrence of “Smith” in the patient database as well as U.S. demographic information indicating that “Smith” was a highly prevalent name.

In some implementations, in addition to calculating the confidence score 422, which represents the likelihood that a particular input field value 312 is likely a duplicate value, the external module 100B may also calculate a non-confidence value, which represents the likelihood that the input field value 312 is not likely a duplicate value. For example, in some instances, where the particular input value 312 is ambiguous, a different combination of the statistical parameters 410, or alternative hypotheses using different statistical algorithms may be formulated for the confidence score 422 and the corresponding non-confidence score 432. In such instances, the external module 100B may calculate an aggregate confidence score that combines the confidence score 422 and the non-confidence score.

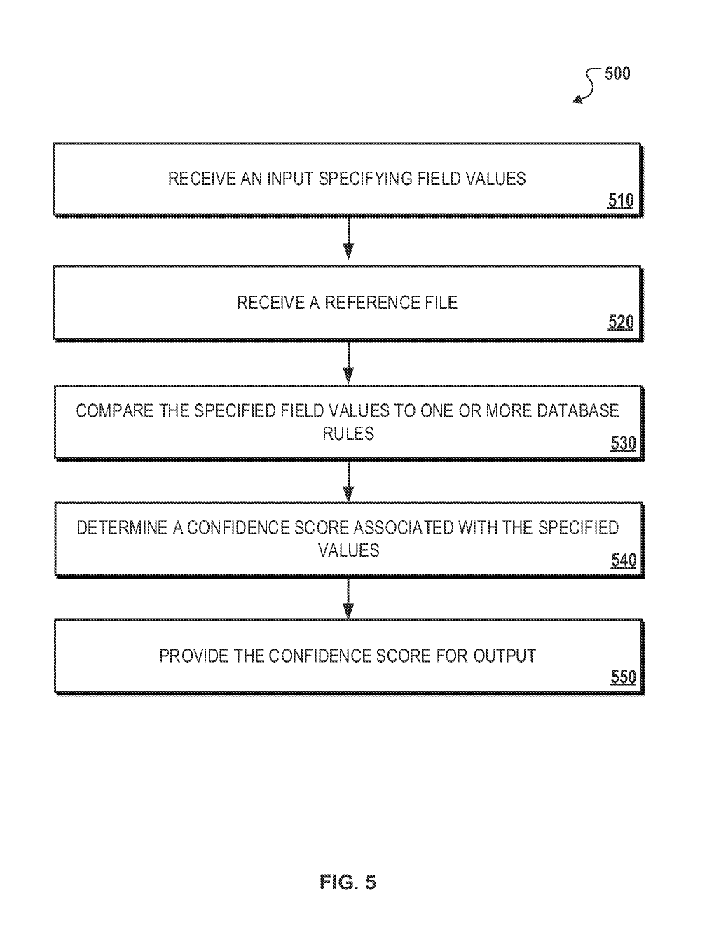

FIG. 5 is an example process 500 for detecting duplicate data in a database. Briefly, the process 500 may include receiving an input specifying field values (510), receiving a reference file (520), comparing the specified field values to one or more database rules (530), determining a confidence score associated with the specified values (540), and providing the confidence score for output (550).

In more detail, the process 500 may include receiving, from a user, an input specifying field values for one or more data fields (510). For example, the external module 100B may receive a user input specifying field values for input data fields 146 such as, for example, “Input Name,” “Input First Name,” “Input Street,” or “Input City.”

The process 500 may include receiving a reference file that specifies one or more database rules for a particular dataset (520). For example, the external module 100B may receive the reference file 132 from the supplier reference database 130. The reference file 132 may specify one or more database rules included in rule generation table 220 for the dataset 210. As shown in the example in FIG. 2, the reference file 132 specifies rule 1, which describes the attributes of the input field values matching field values of a reference database with verified patient information. For rule 1, the reference file 132 specifies a score such as the confidence score that reflects the occurrence of the database rule and a logical expression representing the application of the database rule to the dataset 210. As shown in the example, the reference file 132 specifies a confidence score of “100,” which represents a perfect likelihood that the dataset 210 includes the original patient record for the “Patient ID” with a field value of “568921.” The reference file 132 also specifies a logical expression that represents the application of rule 1 to the dataset 210. As shown in the example, the logical expression may represent the combination of the data fields in the dataset 210 matching the original values in the reference database.

The process 500 may include comparing the field values specified by the input to the one or more database rules in the reference files (530). For example, the external module 100B may compare the field values specified for the input data fields 146 to the database rules included in the reference file 132. As shown in the example in FIG. 2, the reference file 132 includes five rules for different data fields. For instance, module 100B values specified for the data field “Last Name,” against rule 2 to determine if the input field value contains an incorrectly spelled last name such as “Smyth” as shown in the dataset 210.

The process 500 may include determining a confidence score associated with the received input specifying values for the one or more data fields (540). For example, the external module 100B may determine a confidence score associated with the field values specified for the input data fields 146. As shown in the example in FIG. 2, the external module 100B may determine a “30%” confidence score for the field value “Smyth” specified for the “Last Name” field. In such an example, the external module 100B may determine that the field value is incorrectly spelled, but is associated with a correctly spelled field value based on the high prevalence of the correctly spelled field value, “Smith,” making it less likely that the field value specified by the user input represents a unique value.

In some implementations, the external module 100B may determine a record level confidence score that represents an aggregate confidence score for the entire record that includes all of the input data fields 146. For instance, as represented in FIGS. 3A and 3B, the external module 100B may initially calculate field level confidence scores for the individual input data fields 146 using the field scope 320, and then, based on aggregating the individual confidence scores, calculate a record level confidence score using the record scope 330.

The process 500 may include providing, for output, the confidence score associated with the received input (550). For example, the after calculating field level confidence scores for each of the input data fields 146, the external module 100B may calculate a record level confidence score for the entire new data record and generate a confidence level table 240 as represented in FIG. 3B. The confidence level table 340 may be provided to other system components such as the supplier reference database 130 or the internal module 100A.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving, from a user, an input specifying field values for one or more data fields;
receiving a reference file that specifies (i) one or more database rules for a particular dataset, (ii) for each database rule, a score that reflects the occurrence of the database rule within the particular dataset and a logical expression representing the application of the database rule to the particular dataset;
comparing the field values specified by the input to the one or more database rules specified in the reference file;
determining a confidence score associated with the received input specifying values for the one or more data fields based at least on comparing the field values specified by the input to the one or more database rules; and
providing, for output, the confidence score associated with the received input.

2. The method of claim 1, wherein receiving the input specifying field values for one or more data fields comprises receiving input that includes identifying patient information.

3. The method of claim 2, wherein the identifying patient information includes at least one of: first name, last name, date of birth, personal contact number, work contact number, city of residence, state of residence, zip code, driver license number, email address, physical street address, or social security number.

4. The method of claim 1, wherein the confidence score represents a likelihood that the input specifying field values for the one or more data fields includes duplicate data within the particular dataset.

5. The method of claim 1, wherein determining the confidence score associated with the received input specifying values for the one or more data fields comprises comparing the specified values for the one or more data fields to reference statistical data.

6. The method of claim 1, wherein comparing the field values specified by the input to the one or more database rules specified in the reference file comprises:
extracting (i) field values and (ii) record values from the received input specifying field values for the one or more data fields;
comparing the extracted field values against the one or more database rules in a field scope included in the reference file; and
comparing the extracted record values against the one or more database rules in a record scope included in the reference file.

7. The method of claim 1, comprising:
parsing a particular dataset including one or more field values associated with one or more data fields;
determining that at least one of the field values contains duplicate values;
generating one or more duplication rules based at least on the data fields associated with the at least one of the field values containing duplicate values;
for each of the one or more duplications rules, (i) calculating a score representing a number of occurrences of the data fields associated with the at least one of the field values containing duplicate values, and (ii) determining a logical expression representing the application of the duplication rule to the particular dataset ; and
generating a reference file that specifies (i) the one or more duplication rules for the particular dataset, and (ii) for each database rule, the score that reflects the occurrence of the data duplication rule within the particular dataset and the logical expression representing the application of the database rule to the particular dataset.

8. The method of claim 1 comprising:
determining that the value of the confidence score associated with the received input specifying values for the one or more data fields is less than a threshold value;
in response, providing an instruction to a user to submit an additional input specifying different values for the one or more data field; and
determining that the additional input is valid based at least on determining that a second confidence score associated with the received additional input is greater than the threshold value.

9. A system comprising:
one or more computers; and
a non-transitory computer-readable medium coupled to the one or more computers having instructions stored thereon, which, when executed by the one or more computers, cause the one or more computers to perform operations comprising:
receiving, from a user, an input specifying field values for one or more data fields;
receiving a reference file that specifies (i) one or more database rules for a particular dataset, (ii) for each database rule, a score that reflects the occurrence of the database rule within the particular dataset and a logical expression representing the application of the database rule to the particular dataset;
comparing the field values specified by the input to the one or more database rules specified in the reference file;
determining a confidence score associated with the received input specifying values for the one or more data fields based at least on comparing the field values specified by the input to the one or more database rules; and
providing, for output, the confidence score associated with the received input.

10. The system of claim 9, wherein receiving the input specifying field values for one or more data fields comprises receiving input that includes identifying patient information.

11. The system of claim 10, wherein the identifying patient information includes at least one of: first name, last name, date of birth, personal contact number, work contact number, city of residence, state of residence, zip code, driver license number, email address, physical street address, or social security number.

12. The system of claim 9, wherein the confidence score represents a likelihood that the input specifying field values for the one or more data fields includes duplicate data within the particular dataset.

13. The system of claim 9, wherein determining the confidence score associated with the received input specifying values for the one or more data fields comprises comparing the specified values for the one or more data fields to reference statistical data.

14. The system of claim 9, wherein comparing the field values specified by the input to the one or more database rules specified in the reference file comprises:
extracting (i) field values and (ii) record values from the received input specifying field values for the one or more data fields;
comparing the extracted field values against the one or more database rules in a field scope included in the reference file; and
comparing the extracted record values against the one or more database rules in a record scope included in the reference file.

15. The system of claim 9, comprising:
parsing a particular dataset including one or more field values associated with one or more data fields;
determining that at least one of the field values contains duplicate values;
generating one or more duplication rules based at least on the data fields associated with the at least one of the field values containing duplicate values;
for each of the one or more duplications rules, (i) calculating a score representing a number of occurrences of the data fields associated with the at least one of the field values containing duplicate values, and (ii) determining a logical expression representing the application of the duplication rule to the particular dataset ; and
generating a reference file that specifies (i) the one or more duplication rules for the particular dataset, and (ii) for each database rule, the score that reflects the occurrence of the data duplication rule within the particular dataset and the logical expression representing the application of the database rule to the particular dataset.

16. The system of claim 9 comprising:
determining that the value of the confidence score associated with the received input specifying values for the one or more data fields is less than a threshold value;
in response, providing an instruction to a user to submit an additional input specifying different values for the one or more data field; and
determining that the additional input is valid based at least on determining that a second confidence score associated with the received additional input is greater than the threshold value.

17. A non-transitory computer storage device encoded with a computer program, the program comprising instructions that when executed by one or more computers cause the one or more computers to perform operations comprising:
receiving, from a user, an input specifying field values for one or more data fields;
receiving a reference file that specifies (i) one or more database rules for a particular dataset, (ii) for each database rule, a score that reflects the occurrence of the database rule within the particular dataset and a logical expression representing the application of the database rule to the particular dataset;
comparing the field values specified by the input to the one or more database rules specified in the reference file;
determining a confidence score associated with the received input specifying values for the one or more data fields based at least on comparing the field values specified by the input to the one or more database rules; and
providing, for output, the confidence score associated with the received input.

18. The device of claim 17, wherein comparing the field values specified by the input to the one or more database rules specified in the reference file comprises:
extracting (i) field values and (ii) record values from the received input specifying field values for the one or more data fields;
comparing the extracted field values against the one or more database rules in a field scope included in the reference file; and
comparing the extracted record values against the one or more database rules in a record scope included in the reference file.

19. The device of claim 17, comprising:
parsing a particular dataset including one or more field values associated with one or more data fields;
determining that at least one of the field values contains duplicate values;
generating one or more duplication rules based at least on the data fields associated with the at least one of the field values containing duplicate values;
for each of the one or more duplications rules, (i) calculating a score representing a number of occurrences of the data fields associated with the at least one of the field values containing duplicate values, and (ii) determining a logical expression representing the application of the duplication rule to the particular dataset ; and
generating a reference file that specifies (i) the one or more duplication rules for the particular dataset, and (ii) for each database rule, the score that reflects the occurrence of the data duplication rule within the particular dataset and the logical expression representing the application of the database rule to the particular dataset.

20. The device of claim 17 comprising:
determining that the value of the confidence score associated with the received input specifying values for the one or more data fields is less than a threshold value;
in response, providing an instruction to a user to submit an additional input specifying different values for the one or more data field; and
determining that the additional input is valid based at least on determining that a second confidence score associated with the received additional input is greater than the threshold value.
